(19) United States
(12) Patent Application Publication
(10) Pub. No.: US 2006/0280394 A1
(43) Pub. Date: Dec. 14, 2006

(54) Geared cross roller bearing and table device utilizing the bearing

(75) Inventors: Hidekazu Michioka, Tokyo (JP); Masahiko Tamano, Tokyo (JP); Masayuki Imamura, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Thk Co Ltd, Tokyo (JP)

(21) Appl. No.: 10/551,958

(22) PCT Filed: Apr. 13, 2004
(86) PCT No.: PCT/JP04/05267

§ 371 Date: Oct. 6, 2005

(30) Foreign Application Priority Data
Apr. 14, 2003 (JP) 2003-108878

(51) Int. Cl. F16C 13/00

(52) U.S. Cl. 384/588

(57) ABSTRACT

A cross roller bearing includes an outer ring, an inner ring relatively rotatable with respect to the outer ring, and a plurality of rollers accommodated in a roller circulation passage formed between an outer ring side roller rolling groove formed to the outer ring and an inner ring side roller rolling groove formed to the inner ring so that rotational axes of the rollers intersect each other, and a gear is formed integrally with either one of the outer and inner rings.

### FIELD OF THE INVENTION

The present invention relates to a cross roller bearing accommodated with a plurality of rollers between an inner ring and an outer ring.

### BACKGROUND ART

A cross roller bearing is constructed such that a plurality of rollers are accommodated between a V-shaped (angle of 90 degrees) roller rolling portion formed to an outer ring and a V-shaped (angle of 90 degrees) roller rolling portion formed to an inner ring so that rotation axes of adjacent rollers are perpendicular to each other. According to such arrangement, the cross roller bearing can bear load in every directions, with one bearing, such as radial load, axial load, moment load and so on (refer to Patent Publication 1).

Patent Publication 1: Japanese Patent Laid-open Publication No. 2000-161366.

In a case where, for example, an articulate or revolute joint portion of an industrial robot, a swivelling table of a machining center, a rotating portion of a manipulator, a precision table device, an IC manufacturing device or the like is constructed by assembling the cross roller bearing, there will be required a driving source such as motor for driving the table or the like and a gear or gears for transmitting a driving force from the driving source to the table or the like, in addition to the cross roller bearing for guiding the rotation of the table or the like.

In the arrangement in which the cross roller bearing and the gear are separated, in order to prevent deviation in rotation of the table, it is necessary to carry out a centering working so that the rotation centers of the cross roller bearing and the gear accord with each other at the assembling time of the device or like. Moreover, the separate location of the respective parts or members will constitute a bar against requirement of compactness of the device.

### DISCLOSURE OF THE INVENTION

Accordingly, an object of the present invention is to provide a cross roller bearing which can improve a rotational performance of a table or like of a device in which the cross roller bearing is incorporated without carrying out a centering working and can make compact the device. The cross roller bearing of the present invention for achieving the above object comprises an outer ring, an inner ring relatively rotatable with respect to the outer ring, and a plurality of rollers accommodated in a roller circulation passage formed between an outer ring side roller rolling groove formed to the outer ring and an inner ring side roller rolling groove formed to the inner ring so that rotational axes of the rollers intersect each other, wherein a gear is formed integrally with either one of the outer and inner rings.

According to this structure, either one of the outer ring or inner ring of the cross roller bearing is formed integrally with the gear, so that the rotational performance of the table or like can be improved without effecting a centering working between the cross roller bearing and the gear. In addition, the thrust force is applied to one gear from another gear meshed therewith, the thrust force applied to the gear can be stably loaded by using the cross roller bearing. Furthermore, in comparison with the case in which the cross roller bearing and the gear are independently formed, a dimension in height direction, at the time when the integral cross roller bearing and the gear are incorporated in a device, can be made compact.

A plurality of roller circulation passages may be formed in the axial direction of the outer ring or inner ring.

In an arrangement in which the gear is integrally formed with the inner or outer ring, the moment load or radial load is caused to the inner or outer ring by the thrust force of the gear. The plural arrangement of the roller circulation passages in the axial direction can improve the rigidity of the cross roller bearing in comparison with the arrangement of the single roller circulation passage, and accordingly, even if such load is applied to the inner or outer ring, the rotational performance of the table or like can be improved.

It may be desired that a center of a gear abutting surface of the gear formed to the outer periphery of the outer ring and a center, in the axial direction, of two roller circulation passages accord with each other in the axial direction.

According to this structure, a load bearing ability against the thrust force given, to the gear integrally formed to the inner ring or outer ring, from the objective gear (meshed gear) can be improved.

The inner ring may be provided with a protruded portion protruded over the outer ring in the axial direction and the gear is formed to the outer periphery of the protruded portion.

According to this structure, it is not necessary to arrange a gear such as pinion to be meshed with an inner diameter side of the inner ring, so that the inner diameter side of the inner ring can be effectively utilized for other purpose, as through hole, for example, duct hole for wiring.

There may take an arrangement that the outer ring is composed of a first outer ring section formed with a first outer ring side roller rolling portion and a second outer ring section formed with a second outer ring side roller rolling portion, that the inner ring is formed with a first inner ring side roller rolling portion opposing to the first outer ring side roller rolling portion and a second inner ring side roller rolling portion opposing to the second outer ring side roller rolling portion, and that the gear formed to the outer peripheral portion of the inner ring is arranged between the first inner ring side roller rolling portion and the second inner ring side roller rolling portion.

According to this arrangement, the gear is disposed so as to be between the first outer ring section and the second outer ring section, so that the first and second outer rings sections can be separated. Therefore, the rigidity of the cross roller bearing can be more improved.

The other one of the inner ring and the outer rings may be formed with an accommodation hole for accommodating a plurality of rollers into the roller circulation passage so as to penetrate in the radial direction of the other one of the inner and outer rings.

The roller can be accommodated through the accommodation hole without dividing the inner ring or the other one of the outer ring sections, so that the ball rolling portion formed to the inner ring or outer ring can be formed with an improved performance, thus suppressing offsetting of one of the inner or outer ring to which the gear is formed, and hence, suppressing the offsetting of the gear, thereby improving axial alignment between the inner ring or the other one of the outer ring sections and the gear.

Although the gear is not limited to the specific type, hypoid gears, to which a thrust force from an objective gear easily acts, may be preferably utilized.

Furthermore, the present invention may provide a table device which comprises a bed, a table turnable about an axis thereof, and a cross roller bearing for guiding relative rotation of the table with respect to the bed, the cross roller bearing comprising: an outer ring; an inner ring relatively rotatable with respect to the outer ring; and a plurality of rollers accommodated in a roller circulation passage formed between an outer ring side roller rolling groove formed to the outer ring and an inner ring side roller rolling groove formed to the inner ring so that rotational axes of the rollers intersect each other, wherein a gear is formed integrally with either one of the outer and inner rings.

### BRIEF DESCRIPTION OF THE DRAWINGS

FIG. 1 is a sectional view showing a cross roller bearing according to a first embodiment of the present invention.

FIG. 2 is a perspective view showing rollers and retainers accommodated in a roller circulation passage.

FIG. 3A is a sectional view showing the cross roller bearing according to the first embodiment of the present invention.

FIG. 3B is a bottom view showing the cross roller bearing according to the first embodiment of the present invention.

FIG. 4 is a sectional view showing a cross roller bearing according to a second embodiment of the present invention.

FIG. 5A is a plan view showing the cross roller bearing according to the second embodiment of the present invention.

FIG. 5B is a sectional view showing the cross roller bearing according to the second embodiment of the present invention.

FIG. 5C is a bottom view showing the cross roller bearing according to the second embodiment of the present invention.

FIG. 6 is a sectional view showing a cross roller bearing according to a third embodiment of the present invention.

FIG. 7A is a plan view showing the cross roller bearing according to the third embodiment of the present invention.

FIG. 7B is a sectional view showing the cross roller bearing according to the third embodiment of the present invention.

FIG. 7C is a bottom view showing the cross roller bearing according to the third embodiment of the present invention.

FIG. 8 is a side view, partially sectioned, of a table device incorporated with the cross roller bearing of the present invention.

### BEST MODE FOR EMBODYING THE INVENTION

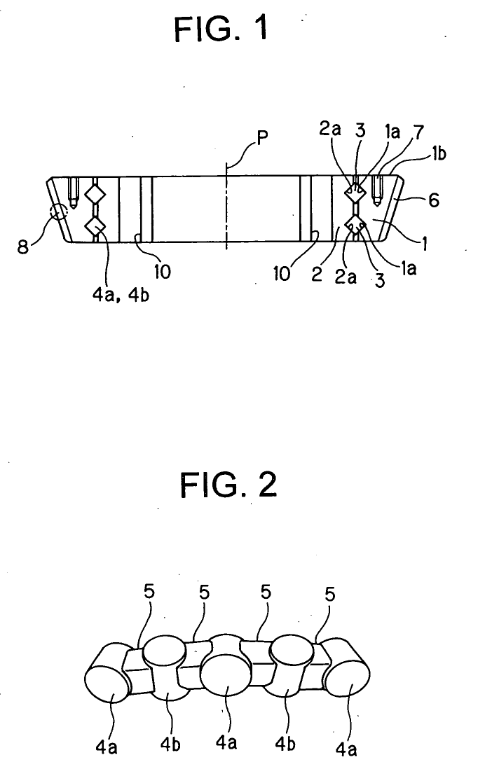

FIG. 1 to FIGS. 3A and 3B represent a cross roller bearing according to the first embodiment of the present invention. Roller rolling grooves 1a, 1a having V-shape (angle of 90 degrees) are formed to an inner periphery of an outer ring 1 as outer ring side roller rolling portions. On the other hand, roller rolling grooves 2a, 2a having V-shape (angle of 90 degrees) are formed to an outer periphery of an inner ring 2 as inner ring side roller rolling portions. Roller circulation passage 3, in form of a ring having substantially square sectional shape, is formed between the corresponding roller rolling grooves 1a and 2a.

In this embodiment, two rows of roller rolling grooves 1a, 1a are formed to the outer ring 1 with a distance therebetween in the axial direction of the outer ring 1, and likely, two rows of roller rolling grooves 2a, 2a are formed to the inner ring 2 with a distance therebetween in the axial direction of the inner ring 2. Accordingly, two rows of the roller circulation passages 3, 3 are also formed with a distance in the axial direction of the outer and inner rings 1 and 2.

In the roller circulation passage 3, a plurality of rollers 4a, 4b, are accommodated in a manner such that the adjacent rollers 4a and 4b have rotation axes extending perpendicularly to each other. As shown in FIG. 2, the rollers 4a (4b) has a columnar shape having a diameter and an axial length which are substantially equal to each other. More in detail, however, the axial length is slightly smaller than the diameter. As viewed along the ring-shaped roller circulation passage 3, the axes of the adjacent rollers 4a and 4b are perpendicular to each other. A retainer 5 is disposed between the adjacent rollers 4a and 4b so as to hold the rollers in their predetermined attitudes.

A plurality of rollers 4a and 4b are classified into two types, one being a grope of rollers 4a directed outward and the other being a group of rollers 4b directed inward. The outward directed rollers 4a are held by the retainers 5 in an attitude such that the rotation axes thereof are directed to a swivel center point positioned on the axial line P of the outer and inner rings 1 and 2. Likely, the inward directed rollers 4b are also held by the retainers 5 in an attitude such that the rotation axes thereof are directed to the swivel center point positioned on the axial line P of the outer and inner rings 1 and 2. According to such arrangement, when the rollers 4a, 4b, - - - circulate in the roller circulation passage 3, the rollers 4a, 4b, - - - roll while sliding on the roller rolling grooves 1a, 1b so that their rotation axes form conical loci

Further, there may be adopted an arrangement of the rollers 4a, 4b, - - - in which two, three, - - - rollers 4a and 4b are alternately arranged with their rotation axes being changed from each other, different from the described embodiment in which the rollers 4a and 4b are arranged one by one alternately.

A gear 6 is formed integrally with the outer periphery of the outer ring 1. More specifically, for example, the gear 6 is formed to the outer ring 1 by effecting cutting working or rolling working to the outer periphery thereof. The wording “the gear is integrally formed - - - ” excludes a case that a gear formed as separate member from the outer ring 1 and then integrally coupled to the outer ring 1 by means of bolt, nut or like.

The kind or shape of the gear 6 is not limited specifically to spur gear, helical gear, bevel gear, worm gear and the like, but, in this embodiment, hypoid gears which transmit rotation between two shafts, which are not parallel with and do not intersect to each other. The hypoid gears are formed by contacting two circular weights having offset axes, to which gear teeth are cut in as pitch circular weight and utilized in a case that two axes constitute a right angle. Such hypoid gears have, different from the bevel gear, an advantage such that the axes can be extended in both directions. Further, a fastening screw or like 7 is formed to an end surface 1b in the axial direction of the outer ring 1 for coupling the outer ring 1 to a rotation objective member such as table.

In this embodiment, the gear 6 of the outer ring 1 has gear teeth formed entirely around the circumferential direction of the outer periphery of the outer ring 1 including portions between the two rows of roller circulation passages 3, 3. The center 8 of a tooth abutting surface of the gear 6 of the outer ring 1 (i.e., center, in the axial direction, of a contacting position between the gear 6 of the outer ring 1 and a gear meshed with the gear 6) and the center of the two rows of the roller circulation passages 3, 3 in axial direction accord with each other in the axial direction. Accordingly, a load bearing ability against a thrust force applied to the gear 6 integrally formed with the outer ring 1 from the objective gear can be improved.

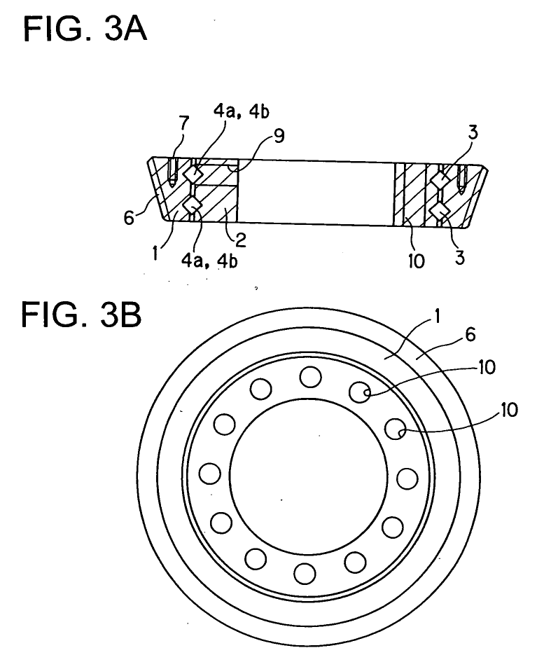

As shown in FIGS. 3A and 3B, the inner ring 2 is formed with an accommodation hole 9 for accommodating the rollers 4a, 4b, - - - and the retainers 5, 5, - - - into the roller circulation passages 3, 3 so as to penetrate through the radial direction of the inner ring 2. Accordingly, by accommodating the rollers 4a, 4b, - - - and the retainers 5, 5, - - - from the accommodation hole 9 without dividing the inner ring 2, axial alignment of the inner ring 2 and the gear 6 can be improved. After the accommodation of the rollers 4a, 4b, - - - and the retainers 5, 5, - - - , this accommodation hole 9 is clogged. Further, in a case that the performance of the axial alignment between the inner ring 2 and the gear 6 does not constitute any problem, the inner ring 2 is divided into three sections of outside ring section, intermediate ring section and outside ring section by a plane intersecting at right angle to the axial line thereof, and after the accommodation of the rollers and the retainers, these three ring sections may be fastened integrally by means of bolt and nut. The inner ring 2 is also formed with a plurality of mount holes 10, 10, - - - for mounting the cross roller bearing to a fixing portion such as bed.

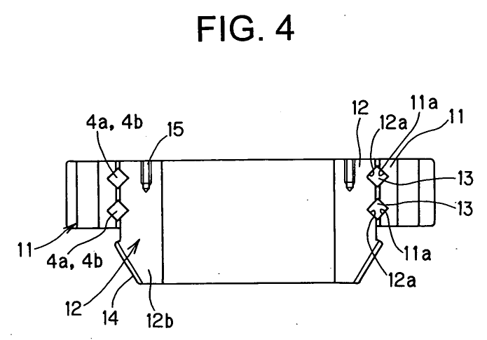

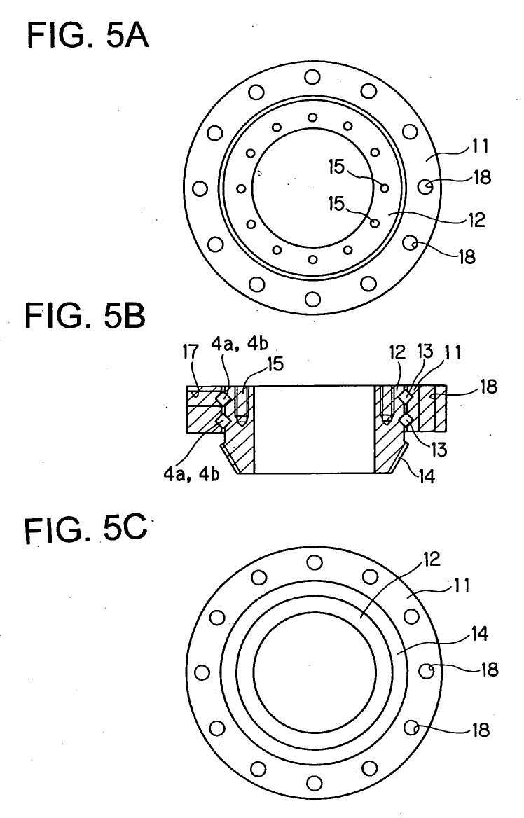

FIG. 4 and FIGS. 5A to 5C represent a cross roller bearing according to the second embodiment of the present invention. Two rows of roller rolling grooves 11a, 11a having V-shape (angle of 90 degrees) are formed to an inner periphery of an outer ring 11 as outer ring side roller rolling portions, and on the other hand, two rows of roller rolling grooves 12a, 12a having V-shape (angle of 90 degrees) are formed to an outer periphery of an inner ring 2 as inner ring side roller rolling portions. Roller circulation passages 13, 13, each in form of a ring having substantially square sectional shape, are formed between the corresponding roller rolling grooves 11a and 12a.

In the roller circulation passages 13, 13, a plurality of rollers 4a, 4b, - - - are accommodated in a manner such that the adjacent rollers 4a and 4b have rotation axes extending perpendicularly to each other. Further, since configurations and arrangements of the rollers 4a, 4b and the retainers 5 are substantially the same as those in the first embodiment mentioned above, same reference numerals are added to corresponding portions or members and description thereof will be hence omitted herein.

The inner ring 12 is formed with a protruded portion 12b protruding over the outer ring 11 in the axial direction. A gear 14 is formed integrally with the outer periphery of this protruded portion 12b. More specifically, for example, the gear 14 is formed to the inner ring 12 by effecting cutting working or rolling working to the outer periphery of the outer peripheral surface of the protruded portion 12b. The wording “the gear is integrally formed - - - ” used herein excludes a case that a gear formed as separate member from the outer ring 11 and then integrally coupled to the inner ring by means of bolt, nut or like. The kind or shape of the gear 14 is not limited specifically to spur gear, helical gear, bevel gear, worm gear and the like, but, in this embodiment, hypoid gears which transmit rotation between two shafts, which are not parallel with and do not intersect to each other. Further, a fastening screw or like 15 is formed to an end surface in the axial direction of the inner ring 12 for coupling to a rotation objective member such as table.

As shown in FIGS. 5A to 5C, the outer ring 11 is formed with an accommodation hole 17 for accommodating the rollers 4a, 4b, - - - and the retainers into the roller circulation passages 13, 13 so as to penetrate through the radial direction of the outer ring 11. Accordingly, by accommodating the rollers 4a, 4b, - - - and the retainers 5, 5, - - - from the accommodation hole 17 without dividing the outer ring 11, performance of the axial alignment of the outer ring 11 and the gear 14 can be improved. After the accommodation of the rollers 4a, 4b, - - - and the retainers 5, 5, - - - , this accommodation hole 17 is clogged. Further, in a case that the performance of the axial alignment between the outer ring 11 and the gear 14 does not constitute any significant problem, the outer ring 11 is divided into three sections of outside ring section, intermediate ring section and outside ring section by a plane intersecting at right angle with the axial line thereof, and after the accommodation of the rollers and the retainers, these three ring sections may be fastened integrally by means of bolt and nut. The outer ring 11 is also formed with a plurality of mount holes 18, 18, - - - for mounting the cross roller bearing to a fixing portion such as bed.

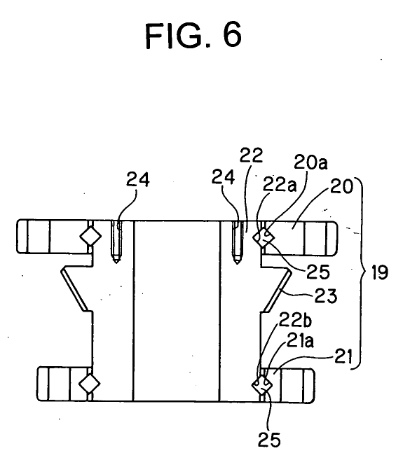

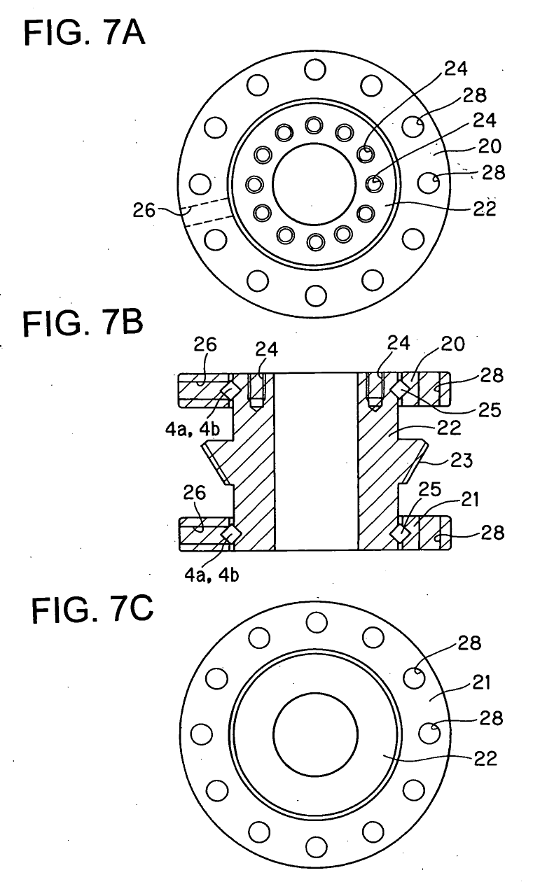

FIG. 6 and FIGS. 7A to 7C represent a cross roller bearing according to the second embodiment of the present invention. A first inner ring side roller rolling grooves 22a and a second inner ring side roller rolling groove 22b both having V-shape (angle of 90 degrees) are formed to an inner ring 22 with a distance in the axial direction. A gear 23 is integrally formed to the outer periphery of the inner ring 22 between the first inner ring side roller rolling groove 22a and the second inner ring side roller rolling grove 22b. More specifically, for example, this gear is formed to the inner ring 22 by effecting cutting working or rolling working to the outer periphery surface of the inner ring 22. The wording “the gear is integrally formed - - - ”, used herein excludes a case that a gear formed as separate member from the inner ring 22 and then integrally coupled to the inner ring by means of bolt, nut or like. The kind or shape of the gear 23 is not limited specifically to spur gear, helical gear, bevel gear, worm gear and the like, but, in this embodiment, hypoid gears which transmit rotation between two shafts, which are not parallel with and do not intersects to each other. Further, a fastening screw 24 or like is formed to an end surface in the axial direction of the inner ring 22 for coupling to a rotation objective member such as table.

The outer ring 19 is composed of a first outer ring (section) 20 and a second outer ring (section) 21 which are formed independently. The first outer ring 20 is formed with a first outer ring side roller rolling groove 20a opposing to the first inner ring side roller rolling groove 22a formed to the inner ring 22. The second outer ring 21 is formed with a second outer ring side roller rolling groove 21a opposing to the second inner ring side roller rolling groove 22b formed to the inner ring 22.

Roller circulation passages 25, 25, each in form of a ring having substantially square sectional shape, are formed between the roller rolling grooves 22a, 20a and 22b, 21a. In the roller circulation passages 25, 25, a plurality of rollers 4a, 4b, - - - are accommodated in a manner such that the adjacent rollers 4a and 4b have rotation axes extending perpendicularly to each other. Further, since configurations and arrangements of the rollers 4a, 4b and the retainers 5 are substantially the same as those in the first embodiment mentioned above, same reference numerals are added to corresponding portions or members and description thereof will be hence omitted herein.

As shown in FIGS. 7A to 7C, the outer rings 20 and 21 are formed with accommodation holes 26, 26 for accommodating the rollers 4a, 4b, - - - and the retainers 5, 5, - - - into the roller circulation passages 25, 25 so as to penetrate through the radial direction of the outer rings. Accordingly, by accommodating the rollers 4a, 4b, - - - and the retainers 5, 5, - - - from the accommodation holes 26, 26 without dividing the inner ring 22, performance of the axial alignment of the outer ring 21 and the gear 23 can be improved. After the accommodation of the rollers 4a, 4b, - - - and the retainers 5, 5, - - - , these accommodation holes 26, 26 are clogged. The outer ring 21 is formed with a plurality of mount holes 28, 28, - - - for fastening the cross roller bearing to a fixing member such as bed. Further, in a case that the performance of the axial alignment between the outer ring 21 and the gear 23 does not constitute any significant problem, the outer ring 21 is divided into two sections by a plane intersecting at right angle with the axial line thereof, and after the accommodation of the rollers and the retainers, these two ring sections may be fastened integrally by means of bolt and nut.

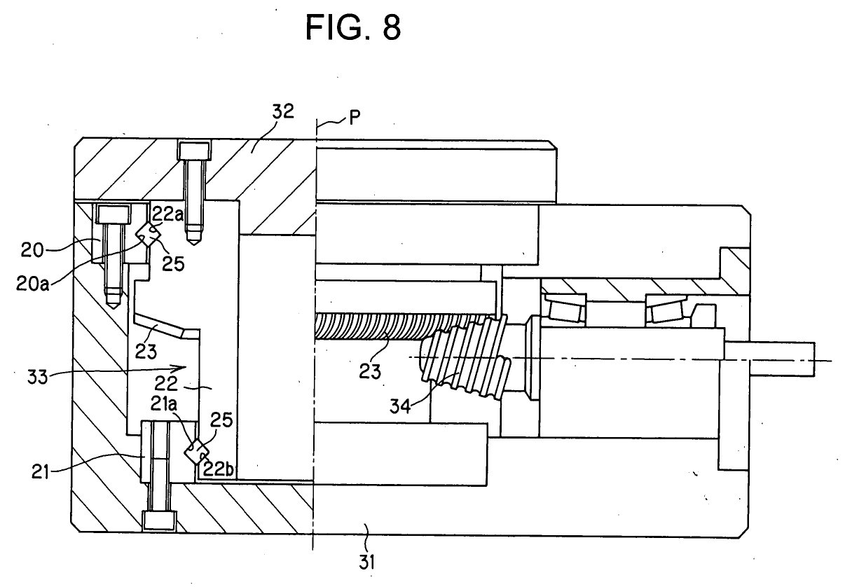

FIG. 8 shows a table device incorporated with the cross roller bearing according to the present invention. The table device is a machine tool for rotating a work (workpiece) to be worked and then working it, and operates to rotate the workpiece by predetermined angles and then work it, or to continuously work the workpiece while rotating it.

The table device comprises a bed 31, a table 32 turnable about its axis and a cross roller bearing 33. The cross roller bearing of the third embodiment mentioned above is utilized as this cross roller bearing 33, so that its description is now omitted herein by adding the same reference numerals.

The outer rings 20 and 21 of the cross roller bearing 33 are fixed to the bed 31 by means of bolt and nut. The inner ring 22 of the cross roller bearing 33 is fixed to the table 32 by means of bolt and nut. A pinion 34 to be meshed with the gear 23 is supported by the bed 31 to be rotatable. This pinion 34 is also composed of hypoid gears, and has an axis, which is not parallel with and does not intersect to the axis of the gear 23 formed integrally with the inner ring 22.

For example, when a workpiece is worked, a moment load may be applied to the table 32 by a force applied to the workpiece from a tool. The inner ring 22 fixed to the table 32 is supported by two rows of roller circulation passages 25, 25 arranged with a distance in the axial direction, so that the resistance against the moment load can be improved in comparison with the case of the single row of the roller circulation passage. In addition, since the gear 23 is disposed between the two rows of roller circulation passages 25, 25, even if thrust force is applied to the gear 23 from the pinion 34, the inclination of the inner ring 22 formed with the gear 23 can be suppressed. Accordingly, even if the moment load is applied to the table 32 and the thrust force is also applied to the gear 23, the rotational indexing performance can be maintained.

As mentioned hereinbefore, according to the present invention, either one of the outer ring or inner ring of the cross roller bearing is formed integrally with the gear, so that the rotational performance of the table or like can be improved without effecting a centering working between the cross roller bearing and the gear. In addition, the thrust force is applied to one gear from another gear meshed therewith, the thrust force applied to the gear can be stably loaded by using the cross roller bearing. Furthermore, in comparison with the case in which the cross roller bearing and the gear are independently formed, a dimension in height direction, at the time when the integral cross roller bearing and the gear are incorporated in a device, can be made compact.

It is to be noted that the present invention may be embodied in other specific forms without departing from the spirit or essential characteristics thereof. The present embodiments are therefore to be considered in all respects as illustrative and not restrictive, the scope of the present invention being indicated by the appended claims rather than by the foregoing description and all changes which come within the meaning and range of equivalency of the claims are therefore intended to be embraced therein.

The entire disclosure of each of Japanese Patent Application No. 2003-108878 filed on Apr. 14, 2003 including the specification, claims, drawings and summary is incorporated herein by reference in its entirety.

1. A geared cross roller bearing comprising:
an outer ring;
an inner ring relatively rotatable with respect to the outer ring; and
a plurality of rollers accommodated in a roller circulation passage formed between an outer ring side roller rolling groove formed to the outer ring and an inner ring side roller rolling groove formed to the inner ring so that rotational axes of the rollers intersect to each other,
wherein a gear is formed integrally with either one of the outer and inner rings.

2. The geared cross roller bearing according to claim 1, wherein a plurality of roller circulation passages are formed in the axial direction of the outer ring or inner ring.

3. The geared cross roller bearing according to claim 2, wherein a center of a gear abutting surface of the gear formed to the outer periphery of the outer ring and a center, in the axial direction, of two roller circulation passages accord with each other in the axial direction.

4. The geared cross roller bearing according to claim 1 or 2, wherein said inner ring has a protruded portion protruded over the outer ring in the axial direction and the gear is formed to the outer periphery of the protruded portion.

5. The geared cross roller bearing according to claim 1 or 2, wherein said outer ring is composed of a first outer ring section formed with a first outer ring side roller rolling portion and a second outer ring section formed with a second outer ring side roller rolling portion,
said inner ring is formed with a first inner ring side roller rolling portion opposing to the first outer ring side roller rolling portion and a second inner ring side roller rolling portion opposing to the second outer ring side roller rolling portion, and
said gear formed to the outer peripheral portion of the inner ring is arranged between the first inner ring side roller rolling portion and the second inner ring side roller rolling portion.

6. The geared cross roller bearing according to claim 1 or 2, wherein another one of the inner ring and the outer ring is formed with an accommodation hole for accommodating a plurality of rollers into the roller circulation passage so as to penetrate in the radial direction of the another one of the inner and outer ring.

7. The geared cross roller bearing according to claim 1 or 2, wherein said gear is hypoid gears for transmitting a rotation between two axes which are not parallel with each other and do not intersect to each other.

8. A table device which comprises a bed, a table turnable about an axis thereof, and a cross roller bearing for guiding relative rotation of the table with respect to the bed,
said cross roller bearing comprising:
an outer ring;
an inner ring relatively rotatable with respect to the outer ring; and
a plurality of rollers accommodated in a roller circulation passage formed between an outer ring side roller rolling groove formed to the outer ring and an inner ring side roller rolling groove formed to the inner ring so that rotational axes of the rollers intersect each other,
wherein a gear is formed integrally with either one of the outer and inner rings.
